(19) United States
(12) Patent Application Publication
(10) Pub. No.: US 2002/0059378 A1
(43) Pub. Date: May 16, 2002

(54) System and method for providing on-line assistance through the use of interactive data, voice and video information

(76) Inventor: Shakeel Mustafa, Tustin, CA (US)

Correspondence Address: SHAKEEL MUSTAFA, 15520 TUSTIN VILLAGE WAY # 2, TUSTIN, CA, 92780, US

(21) Appl. No.: 09/931,531

(22) Filed: Aug. 17, 2001

Related U.S. Application Data
(60) Provisional application No. 60/226,025, filed on Aug. 18, 2000.

(51) Int. Cl. G06F 15/16

(52) U.S. Cl. 709/205

(57) ABSTRACT

A system and method are disclosed that relate to interactively providing assistance and help to on-line clients by means of data, voice, and video communication. The scheme can facilitate real-time and on-line communication between a client and an agent. A designated helping agent can access any permitted source on the network and can provide on-line help to a client in real time. The proposed method once set up, requires a single click of the mouse, or a single step of instruction by any means from a client to acquire on-line help through the use of multimedia interactive communication. The scheme also describes a flexible methodology that can be used by an agent to build personalized customer profiles. The information saved in multiple profiles can be aggregated by the automated system to be used in future help sessions. The resulting user profile enhances the quality of service through live help or by automated systems to automatically deliver the related information by any means of data, voice, and video communication to a client.

### BACKGROUND OF THE INVENTION

The Internet comprises a vast number of computers, network links between the computers, protocols, and other interface standards that provide a means of exchanging data among different people using the computers. The Internet was originally designed for defense purposes but in the recent years it has accommodated a big transition towards the commercials aspects. The Internet is rapidly emerging as a “virtual mall” where every possible imaginable item and product can be made available and can be bought and sold on-line. There are millions of transactions of every sort taking place on E-commerce sites every day. As the Internet is rapidly exploding for universal commercialization, there is one thing which is tremendously lagging behind this explosion and that is traditional customer service, with the lively and smiling faces of human beings ready to assist their customers and clients. Because of the lack of proper information and lack of the right guidance and help on the Internet, which is integral for customers satisfaction, millions of customers feel frustrated while visiting the virtual commercial sites. A majority of the time the on-line clients cannot find their way out through the maze of embedded hyperlinks in order to get to the proper Web page and find the right product. With advancement in the HTML (HyperText Markup Language) the Web pages can be designed in very sophisticated and glamorous ways but the new trends in the design philosophies accomplish little for the on-line client who are striving to navigate through the Web to find very basic items. The Forrester's Online Retail Strategies Group surveyed that only 2.7% of online shoppers make the leap from browser to buyer.

As the number of on-line users are increasing, newer technologies are emerging very rapidly to provide end users with multiple options to access the Internet through high speed connections. The new access technologies include cable modems, different flavors of DSL technologies, high speed wireless access, and many more. Also, continuous new advancements in the compression techniques are introducing new ways to deliver multimedia communication to end users with much less required access bandwidth. As a result it is getting easier and more practical to deliver a live communication channel over the Internet or any other network.

Having said that, there is a strong need for a methodology that can provide a way for the clients using the Internet, or any other network, to interact with the live helping agents through means of multimedia communication that can provide on-line help in real time and guide the clients in the right direction. The live interaction also provides a live human touch that understands the emotions and feelings of the clients. The preferred technique can also exploit any number of communication methods (data, voice and video) to provide real time, on-line assistance to the client.

### SUMMARY OF THE INVENTION

A system and method to provide interactive and on-line help to clients using any cluster of networks including the Internet. The preferred techniques provide a way to activate and obtain on-line live help to any registered Web site through minimum client interaction which may include a single click of the computer mouse.

Another object of the present invention is to use multimedia communication to provide a client with live and on-line help by means of data, voice, and video communication.

Yet another object of the present invention is to use a premium network characterized by a desired quality of help to the end client. However, the concepts illustrated in the present invention can also be exploited over the Internet alone.

It is a further object of the present invention to provide a mechanism that can initialize help sessions through minimum client input. In one embodiment, the functionality of the present invention can be incorporated within the existing infrastructure for providing live help through conventional means (e.g., telephone) by customer service representatives. Through the use of the present invention the existing helping agents of a company can be seamlessly migrated to provide the interactive quality of service to on-line clients over the Internet by means of multimedia communication.

An even further object of the present invention is to provide a technique that can be used by a helping agent to access any permitted resource over the Internet and then convey the related information to the on-line client with live and active interaction.

Still another object of the present invention is to provide a technique that can uniquely identify a certain client on a particular client system and then redirect and even migrate the client's existing communication access path to an assigned network of helping agents. This supported functionality and these features are fully automated and are completely transparent to the end client seeking help.

Yet another object of the present invention is to provide a mechanism that can determine, according to the client priority and importance level, which and how the premium network resources or the Internet resources should be allocated to provide the said client on-line help.

Yet another object of the present invention is to provide a method that can be used by a client and a helping agent to observe and download the same Web page simultaneously with two different mouse cursor shapes, and mutually identified by the client and helping agent on the said Web page.

Still another object of the present invention is to disclose a technique that can visually display a mechanism to interactively and simultaneously monitor the download flow of data at client and helping agent systems.

Yet another object of the present invention is to provide a technique that can be used to inter-exchange active Web pages between a client and an agent system in real time during on-line help sessions.

Yet another object of the present invention is to utilize a technique that continuously monitors the reception rate of the video information. If the video information rate falls below a predetermined level then the reception mode is switched to voice only. An implemented simulation process utilizes the previous stored video frames, and associate with the new voice information to simulate a live picture.

It is another object of the present invention to consolidate the diverse information fields in the plurality of profiles belonging to an individual client and then assign a net priority ranking in the resulting profile. The assigned priority ranking can be used to identify certain clients and then the automated multimedia communication can be used to deliver the related information during off-line or on-line sessions of the said clients.

These, together with the other objects of the invention, along with the various features of novelty which characterize the invention, are pointed out in this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 illustrates a typical network architecture with a dialup and LAN access commonly used to access Web servers over the Internet.

FIG. 2 shows the proposed network architecture with the inclusion of a proposed premium FR/ATM network to be used in conjunction with the preferred embodiment.

FIG. 3 shows the client Web page view which includes a hyper-link pointing to a designated help Web site (e.g., 1-clickhelp.com).

FIG. 4 represents a typical database file containing plurality of profiles for the registered users authorized to receive on-line help for different designated Web sites.

FIG. 5 illustrates the client Web page view containing verification and other multiple configuration options pertaining to a specific authorized user.

FIG. 6 shows the initial welcome view on a client Web page after a user has been properly identified.

FIG. 7 shows the client Web page in the process of receiving on-line help.

FIG. 8 illustrates the same Web page view from the helping agent's perspective when the on-line help session is in progress.

FIG. 9 represents the consolidating information process of multiple information fields pertaining to multiple profiles of a single user.

FIG. 10 is a process flow chart for prioritizing voice/video information over data.

### DETAILED DESCRIPTION OF THE PREFERRED EMBODIMENT

Before explaining the present invention in detail, it is to be understood that the invention is not limited in its application only to Internet, but its functionality and working methodology can be applicable and well extended to any cluster of networks, e.g., Intranet, Extranet, etc. Also it is to be understood that the phraseology or terminology employed herein is for the purpose of description and not of limitation.

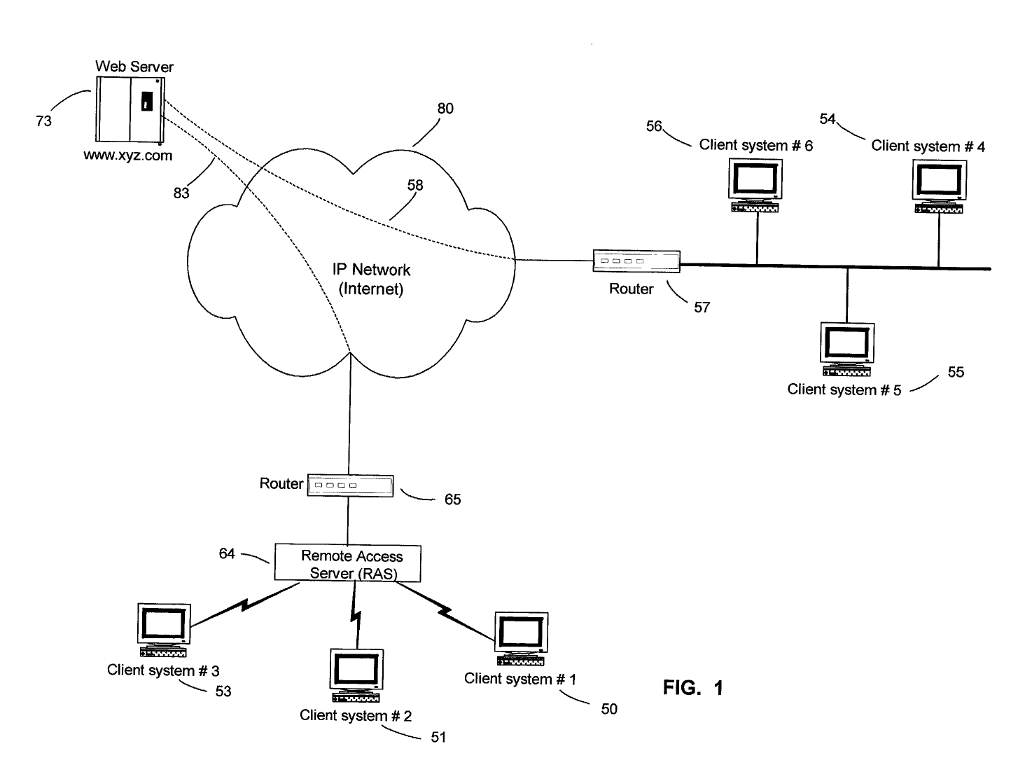

FIG. 1 is the diagram that illustrates a typical network architecture used in the Internet access. In the illustrated LAN access scenario the client systems, 54, 55, and 56 are directly connected to a proper LAN port of an Internet access router 57. The router 57 accesses the Internet 80 through its WAN port and forwards the received IP datagrams over the Internet 80 to a destination Web server 73. In a dialup scenario, clients systems 60, 61, and 63 dial up into a remote access server (RAS) 64 and after proper authentication a client system (e.g. client #1, 60) can access Web server 73 which hosts a sample Web site, www.xyz.com. The client system #1, 60 displays the information of interest (Web page) on the said client monitor.

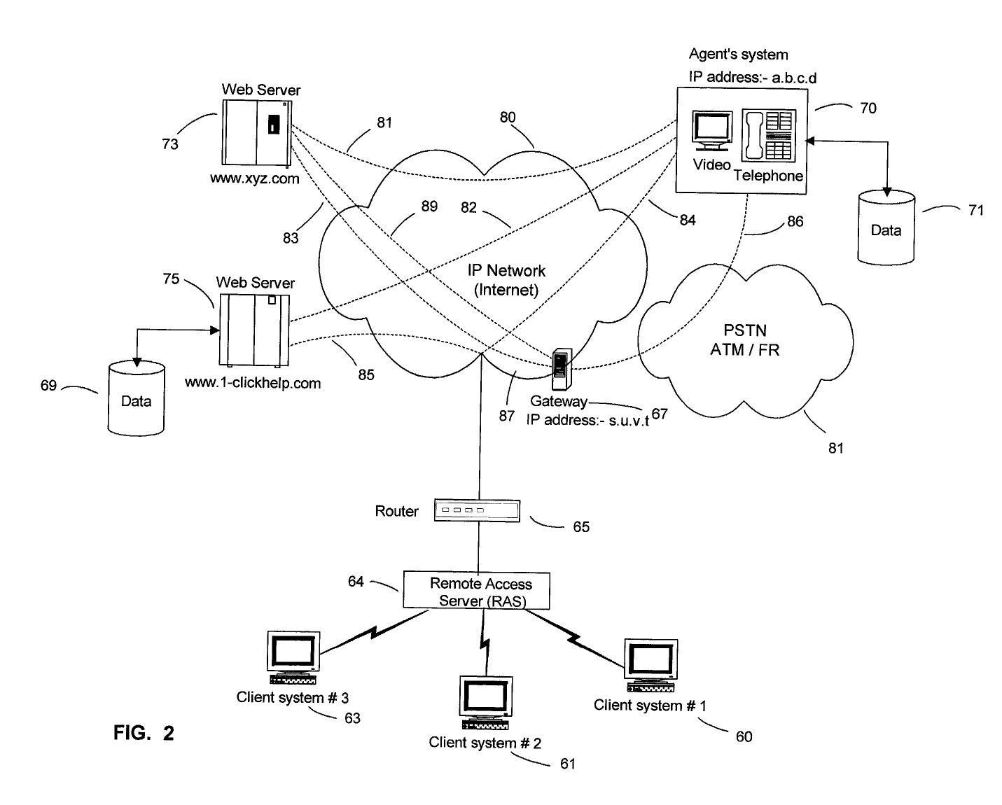

As shown in FIG. 1 any information exchange including data and multimedia communication between the client system #1, 60 and the Web server 73 takes place exclusively over the Internet 80. Since the Internet has evolved as a complex cluster of many diverse network components being maintain by a variety of different service providing organizations, it has become very difficult to provide a steady quality of service (QoS) on the Internet. By definition, an on-line help service relying heavily on the seamless flow of multimedia communication on the Internet needs to provide the help information in real time and in interactive mode. To bypass the present Internet limitation and to provide a high quality of service, a private network based on a high performance ATM/FR network is suggested to be built with the presented scheme. However, it should be realized that the present invention does not require a separate network to accomplish its functionality. The proposed ATM/FR based network can be exclusively maintained by the on-line help providing service organization. To maintain a desired QoS the proposed network carries the on-line help based traffic between an agent providing on-line help to a client. The suggested network can contain multiple gateways (e.g., Gateway 67 as shown in FIG. 2) deployed at different geographical locations and are connected to agent's help sites via premium ATM/ FR network PVCs.

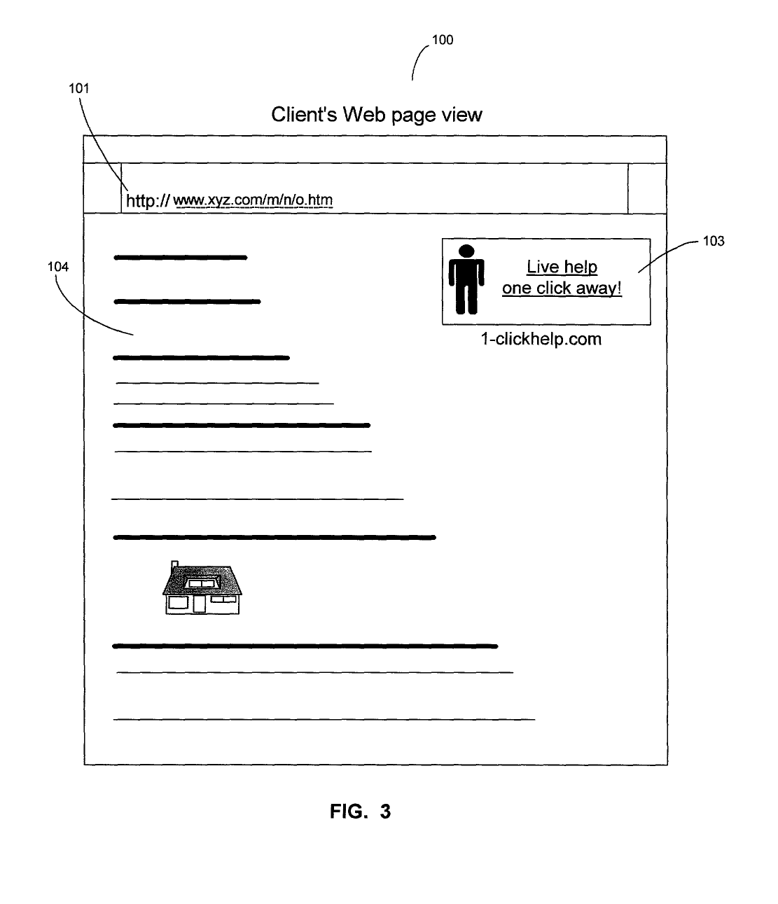

FIG. 2 illustrates the network architecture of the preferred embodiment that can provide extensive on-line help to a client by means of live data, audio, and video information exchange to a very specific detail. As illustrated, the client system #1, 60 accesses the Web server 73 hosting the sample Web site, www.xyz.com, through the Internet link 83 over the Internet 80. The contents of the sample Web page downloaded from the Web server 73 are displayed on the client system #1, 60 as shown in FIG. 3. The Web site (www.xyz.com) supports and provides the online live help feature in accordance with the preferred embodiment. As shown in FIG. 3, this on-line help access is linked through a software applet 103 as displayed in the Web contents 104 and points to an on-line help Web site, 1-clickhelp.com. If the client using the client system #1, 60 needs on-line help, he/she clicks on the icon 103. The software applet 103 launches the embedded program which first searches for its pre-installed components, if any, in a specific folder or directory located on the client system #1, 60. If the related software at the client system #1, 60 is not installed then the software applet 103 sends a message to the Web server 75 requesting a new installation. Prior to the described step, the related IP address of the help Web server 75 hosting the Web site, www.1-clickhelp.com, is obtained by the said client system through the conventional DNS resolution process.

In response to the request, the help Web server 75 (FIG. 2) transfers the installation Web page to the client system #1, 60. The installation Web page on the said client system gathers the necessary information related to the client accessing the said client system. The said information is used to build the initial profile for the particular client using the client system #1, 60. The created profile is sent back to the Web server 75. Once the Web server 75 validates the received profile it creates the relevant entries in its database and assigns a unique sequence number to the client system #1, 60. This unique serial number is sent back to the said client system and is stored in a specific folder or directory. If the related software has already been installed on the said client system at some previous session then it contains the previously described unique and distinct serial number. After obtaining the IP address of the Web site 1-clickhelp.com through DNS resolution, the software applet 103 forwards the serial number to the Web server 75 through a link 85 over the Internet 80 as shown in the FIG. 2. Upon receiving this unique serial number the Web server 75 queries its database 69 to determine which Web site addresses have been registered under this unique serial number.

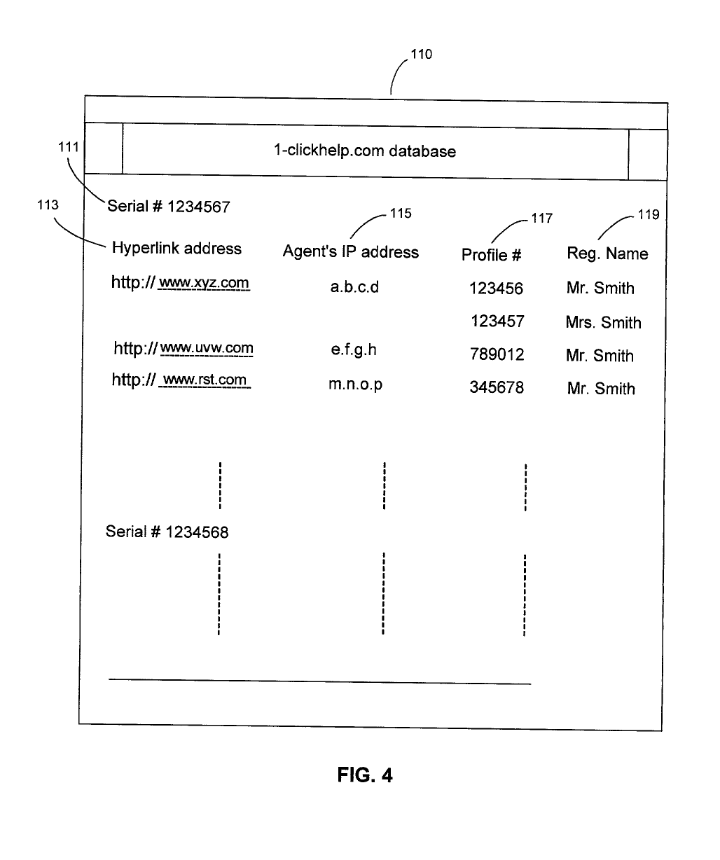

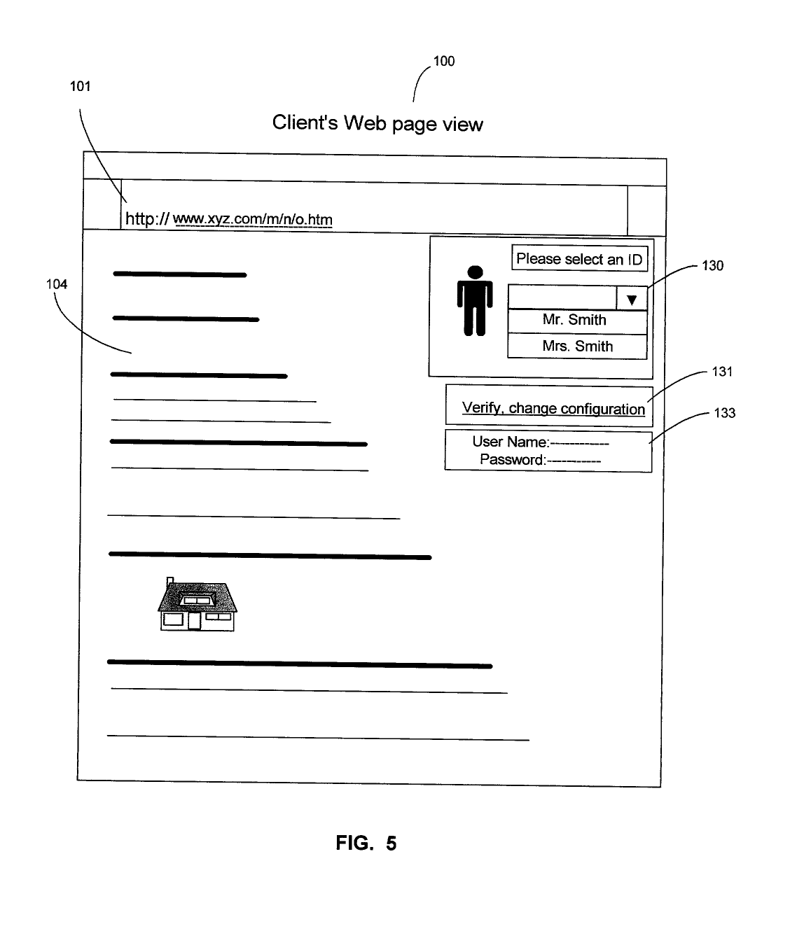

FIG. 4 shows some typical data fields being used in the query process by the Web server 75. The serial number field 111 contains the unique number (1234567) sent by the client system #1, 60. Under the said serial number 111 all the hyperlink addresses of the Web sites authorized for the said client system are listed. The IP addresses of the corresponding helping agent systems authorized to provide help for the said Web sites are also listed with the stored addresses. The profile number field 117 contains the authorized clients' profile numbers who are registered with the specific Web sites addresses. A profile file associated with a unique profile number contains information related to a said client. If multiple clients have accessed the same Web site through the same client system then each client's profile is stored under a unique client number associated with the client's registered name. Referring to FIG. 4, for instance, the Web site www.xyz.com indicates that it has two distinct profile numbers associated with registered client names Mr. Smith and Mrs. Smith. In this situation the Web server 75 sends an inquiry to the software applet on the client system #1, 60 to determine the client ID. As shown in FIG. 5, a dropdown menu 130 appears at the screen with all the multiple clients' IDs who are registered through a certain client system. The software applet also provides the options to verify and change configuration 131 of the present setting. If the name and password is required for a certain client then the window 133 appears to collect this information. The Web server 75 can use standard authentication procedures (e.g., PAP, CHAP) to validate a certain client ID. Once the client selects a proper ID (e.g., Mr. Smith) this information is passed back to the Web server 75. At this point the Web server 75 reads the IP address 115 of the assigned helping agent system (i.e., IP address=a.b.c.d) from its database entries 100 as illustrated in FIG. 4. Using the said IP address the Web server 75 directly establishes a transport connection with the agent system 70 through the link 82 over the Internet 80 as shown in FIG. 2. The Web server 75 sends a request to the agent system 70 to accommodate the client system #1, 60 for providing help. The said Web server can also send additional information about the specific client seeking help to the agent system 70 that can facilitate the decision process for the agent system 70. The Web server 75 then awaits for the request approval from the agent system 70. In the event if the agent system 70 does not have enough available resources, because of congestion or any other reason, then the said agent system sends a message back the Web server 75 informing its inability to accommodate the request and, if possible, can also send a list of backup agents' IP addresses. The Web server 75 can also contain single or multiple IP addresses of the backup agent systems in its database 69 that can also be used to provide on-line help. With a predefined criteria the Web server picks up the next qualified IP address of the helping agent system and sends the request for the connection. This process is repeated until an agent system can accommodate the request to provide on-line help to the client #1, 60. For illustration purposes, considering that the agent system 70 has accepted the request to provide on-line help to the Client system #1, 60, the said agent system notifies the Web server 75 for the request approval and internally allocates the necessary resources to accommodate the request. The Web server 75 then sends the client's (Mr. Smith in this case) profile number (123456), the complete hyper link address of the Web site received by the client system #1, 60 (www.xyz.com/m/n/o.htm), and the IP address of the requesting client system #1, 60 to the agent system 70 for further network connectivity. In one aspect of the invention the Web server 75 can also contain the client profile file in its database 69. In this case the Web server 75 sends the profile file to the said agent system along with other information.

Once the agent system 70 receives the client profile number it retrieves the profile contents from its database 71 to examine the client importance level. The client importance level field is one of the many customized defined fields in the profile file representing the individual characteristics and behavior of the client. The profile can indicate client importance or priority level driven from the past responses or financial transactions executed in the previous sessions. Depending on this priority ranking, the agent system 70 can decide which premium service level should be used to deliver the information to the client system #1, 60. Since the client profile also contains the geographical location of client system #1, 60 the agent system 70 can query its database 71 to find the closest and available gateway nearest to the said particular location. Upon query, it determines that gateway 67 is the closest and available gateway. At this point the agent system 70 has the following multiple choices to deliver the information from the Web server 73 hosting the Web site www.xyz.com to the client system #1, 60.

1) The agent system 70 can establish a direct connection with the Web server 73 through link 81 over the Internet 80 and then acting like a proxy server redirect the received Web pages to the client system #1, 60 through the premium ATM or Frame Relay network directly to the client system #1, 60. In this case the TCP session flow control is directly maintained by the agent system 70 and the client system #1, 60 over the PVC 86 and the IP link connection 87. In this case the role of the gateway 67 is to only facilitate the proper communication mechanism between ATM/FR network 81 and Internet 80.

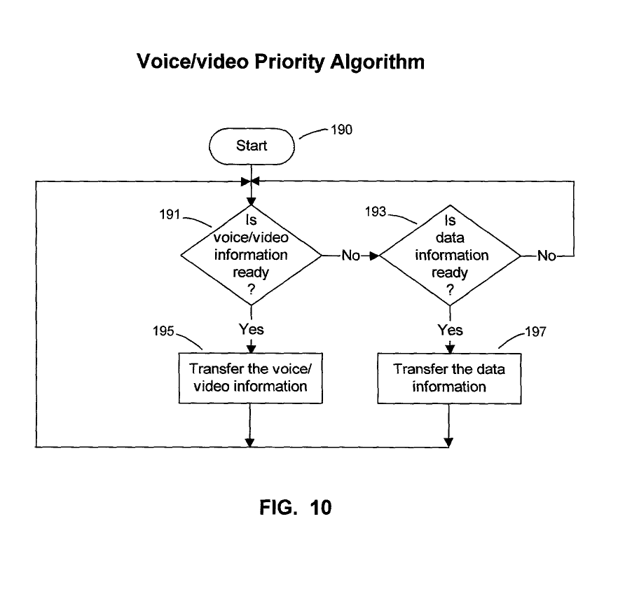

2) The gateway 67 can act like a proxy server and directly fetch the requested data information from the Web server 73 through the link 89 over the Internet and deliver the data to the client system #1, 60. The on-line priority voice/video information from the agent system 70 can be directly received via the ATM/FR network 81. The gateway 67 utilizes a priority algorithm as illustrated in FIG. 10 to prioritize the voice/video traffic being received from agent system 70 over the data traffic being delivered through Web server 73. Using this priority mechanism, the on-line help information in the form of multimedia communication is always prioritized over data. For better performance, the gateway 67 itself maintains a direct TCP session flow control with the client system #1, 60.

3) The client system #1, 60 maintains the responsibility of accessing data directly from the Web server 73 through the link 83 over the Internet 80. The said client system receives the voice/video based on-line help information directly from the agent system 70 through the link 86 configured over the ATM/FR network 81.

4) The client system #1, 60 receives data directly from the Web server 73 through the link 83 over the Internet 80. In addition to that it also receives on-line help (voice/video information) directly from the agent system 70 through the link 84 over the Internet 80.

In the last presented option, #4, there is no requirement to have either a separate premium quality network (ATM/FR) or gateway deployed. The existing Internet infrastructure can be utilized to access data as well as multimedia information for on-line help directly from the respective resources.

As it can be seen from the above presented scenarios that each choice has its pros and cons. Scenario #1 may offer a better quality of service at the expense of using its own network resources and also carrying client's traffic on its network. Scenario #2 and #3 also utilize some of the premium network resources but can provide a better performance than the Internet alone. Scenario #4 does not require the existence of premium network resources but offers a poor response to the multimedia services being transmitted over the Internet. Depending upon the priority level information, as provided in the client's profile, the agent system 70 can select any of the above mentioned available choices to deliver the desired information to the client system #1, 60.

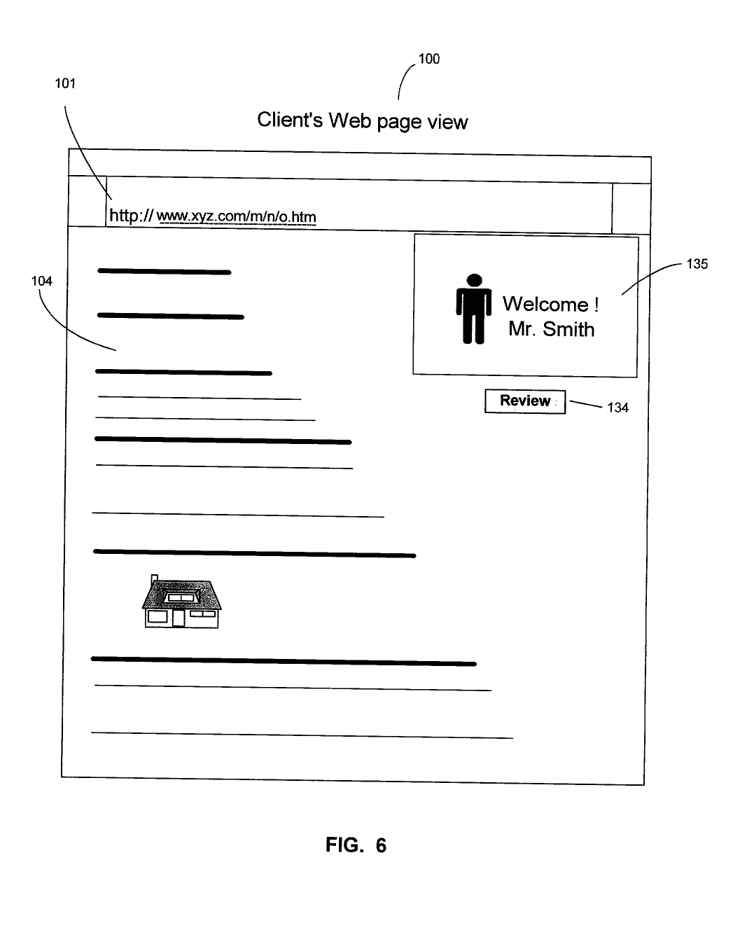

Once a proper method for delivering the information to the client system #1, 60 is identified and selected then the agent system 70 sends a welcome screen to the said client system. The welcome screen indicates that the said client's profile using the client system #1, 60 is validated and the said client is authorized to receive help. FIG. 6 shows a Review icon 134 with a hyper-link that points to the specific area of the said client's profile containing the information fields related to the previous transaction(s) or any other reminders that the said client might be interested in accessing. At this point if the said client chooses to click on the Review icon 134 then the related information is downloaded from the Web server 75 to the said client system. The present invention can offer several different options from this stage. In accordance with one aspect of the present invention, after receiving the information related to the client profile, the Review icon 134 changes to a Help icon on the client web page view 100. If the said client is satisfied with the received information through the profile information fields he/she may not seek additional on-line help. On the other hand if the client still needs to receive on-line help then the said client clicks on the Help icon and then he/she is put into the waiting queue for on-line help. In accordance with another aspect of the present invention, when a client clicks the Review icon 134 he/she can access the information contained in the related client's profile and while the said client is reviewing the received information he/she can be automatically put into the waiting queue to access on-line help.

In another aspect of the present invention the Web server 75 consults the said client's profile to determine if there is any updated information of interest to the client available anywhere over the Internet. If so, it retrieves the said information and sends it to the client system #1, 60. It can also transmit any multimedia files from its own data storage 71 that may relate to the client's interest, or can simply put the client on hold for the next available agent. Those skilled in the art will appreciate that there can be many other configurable options that can be designed within the scope of the present invention.

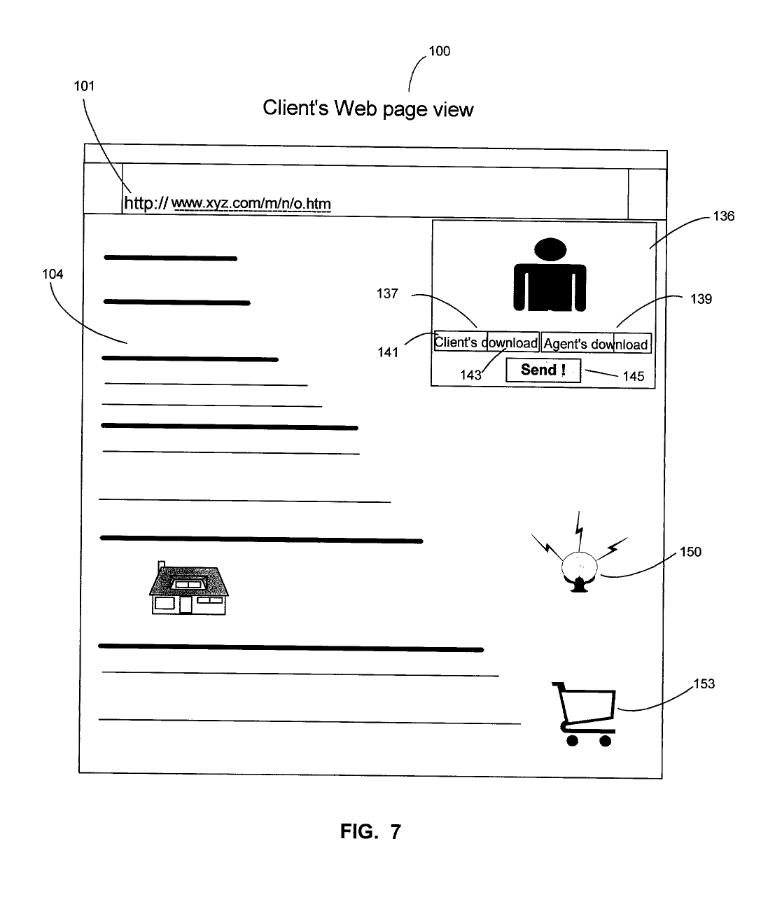

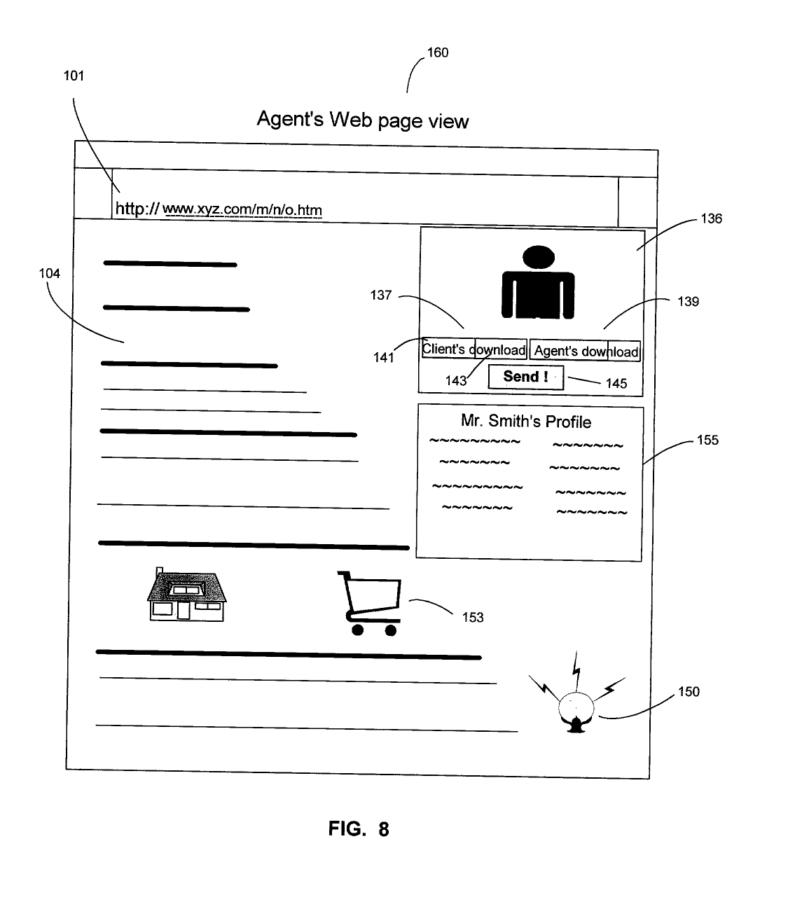

Once an agent becomes available the software at the agent system 70 instructs the software applet running at the client system #1, 60 to change the mouse cursor shape. At this point the agent and the client systems display the exact same Web page which is downloaded from the Web server 73 using the complete hyperlink address. As shown in FIG. 7 the two distinct and different mouse cursors, 153 and 150, appear on the said client's screen which distinguish between the client and agent mouse cursor. Similarly, the said agent also views the same two cursor shapes located at the same position at the agent display screen. The client at the client system #1, 60 controls the mouse cursor 153 movements while the responding agent at agent system 70 has the control over the mouse cursor 150. If the mouse cursor position is changed at either said client or agent system then the new coordinates of the mouse cursor positions are frequently exchanged and updated between the client system #1, 60, and the agent system 70. This simultaneous display of both mouse cursors' positions at both said systems provides a highly interactive environment in which the said client and the agent can independently refer to any location on the screen for further live discussion and explanation. In FIG. 7 and 8, for example, the client mouse cursor shape is shown as 153 and agent mouse cursor shape is displayed as 150 on both the said client and agent display screen. Since both mouse cursor shapes are unique and readily distinguishable from each other there will not be any ambiguity with reference to the cursor shape during the course of information exchange.

FIG. 7 shows a typical view of the client system #1, 60 during a live on-line help session with the agent system 70. The live video of the helping agent with the associated voice is displayed in a small display window 136. The corresponding voice information of the live video of the helping agent can be played out in real-time through the speakers of the client system #1, 60. A client at the said client system can move its cursor to any location of the Web page 100 and the helping agent can provide on-line information through the displayed video window 136. The software applet running at the client system #1, 60 provides a client at the said client system with the ability to move the position of the display window 136 at any location on the displayed Web page view 100. This feature can provide a flexibility for the said client at the client system #1, 60 to access any information of interest that may be hiding underneath the display window 136.

The preferred embodiment also provides a flow control mechanism for data and voice/video information exchange between a client system and an agent system. For a better voice/video quality reception it is desired that the voice/video transmission should always have a precedence over data transmission. Also, the voice/video information needs a steady transmission rate and should not be interrupted by a sudden burst of data information during its course of transmission. The present embodiment uses a simple technique that can reduce the possibility of interrupting the voice/video traffic by data traffic. FIGS. 7 and 8 show two rectangular bars, 137 and 139, that continuously display the download status of data information at the client system and the agent system respectively. During a data download session when either a client system or an agent system accesses data information from any source the download complete status is frequently updated and exchanged between the client and the agent system. For a better reception of video/voice information it is highly recommended not to initiate any multimedia communication during data download activity or vice versa. This disciplined approach can ensure that a client system, generally with low access bandwidth, does not initialize another data session inadvertently which can decrease the link bandwidth being utilized by the voice/video information download. To further enhance the download status display different colors 141 and shades 143 can be included in the status bars 137 and 139.

FIG. 8 shows a typical view of the agent system 70 which displays the same Web page contents 104 as the client system 60 does during an on-line help session. The said agent system also displays the active client profile to facilitate assistance and help the agent to understand the priorities and preferences of the said client. It should be noted that the view window 136 at the agent system 70 does not need to play the live video of the client at client system #1, 60. As a matter of fact, for privacy issues and also to reduce the bandwidth utilization it is recommended not to use the live video of the client accessing the client system #1, 60. Instead, the view window 136 at the agent system 70 can play the outgoing video of the helping agent to provide the agent with an active feedback.

Referring back to FIG. 7, during an interactive on-line help session, if a client at the client system #1, 60 needs assistance then the said client clicks on any of the related hyper-links to single or multiple down-levels of the Web page contents 104. Once the said client accesses the related Web page where the assistance is needed, the said client clicks on the send button 145. The software applet at the said client system sends the complete hyper-link address to the agent station 70. It is also possible to select a configurable option on the software applet so it can send the hyper-link information right away to the agent station 70 as the client on the said client system clicks on a hyperlink. As discussed earlier, the client system #1, 60 can access the Web server 73 or any other Internet resource through three different mechanisms (directly, through gateway 67, or through agent station 70). If the client system #1, 60 is configured to directly access the Web server 73 it starts to download the data information associated with the requested hyperlink through link 83 over the Internet 80 as shown in the FIG. 2. If the said client system is configured to use gateway 67 or agent system 70 it uses the said resources to download the related data information from the Web server 73. As the agent system 70 receives the hyper-link address from the client system 60 it contacts the Web server 73 and initiates the download session. During the download session the client system #1, 60 and the agent system 70 continuously update the download status which is visually displayed through the rectangular bars 137 and 139 as shown in FIGS. 7 and 8. Once the download is complete the said client and the helping agent can initiate an on-line dialogue confirming the identical Web page contents and can continue to exchange further help information.

Similarly, in response to an inquiry initiated by the client, the helping agent at the agent system 70 can access the information of interest from the Web server 73 or any other Internet resource which is uniquely identified by an accessible hyperlink address. The helping agent can review the retrieved information in advance, if desired. Once the said agent determines that the downloaded information is related to the client inquiry and can be helpful, he/she clicks the send button 145. This action sends the complete hyperlink address to the client system #1, 60. The software applet running on the said client system uses this received hyper-link address to download the information from the identified Internet resource. As stated earlier, the download status is actively exchanged between the client system #1, 60 and the agent system 70. When the download is complete then either the said client or said helping agent can initiate multimedia communication to further refine the help information.

The presented scheme can further support the direct transfer of the Web pages between a client system and an agent system, if desired. A “direct send” option can be displayed by the software applet at the client system #1, 60 and at the agent system 70. If this option is invoked both systems establish a TCP/IP connection between each other and transfer directly the Web page contents displayed at one system to the other. One very important use of this scheme can be implemented in reviewing and executing on-line financial transactions. Multiple parties can review the contents of a financial transaction on-line and exchange any related information through multimedia communication before executing it.

The preferred embodiment can also support a mechanism that can temporarily suspend the transmission of video information during the period of bandwidth congestion from the transmitting agent system 70 to the receiving client #1, 60. The software applet running at the said client system continuously monitors the video information rate being received. It also measures the peak receive rate of the video information and compares the receive rate with a certain minimum value which is already pre-configured in the said client system. If the measuring results show that the receive peak rate continuously falls behind the required minimum value then it sends a message to the originating agent system 70 to switch to voice mode only. In the voice mode the said client system 70 only delivers the audio information to the client system #1, 60 which consumes much less bandwidth resources as compared to video information at the said client system access link.

In order to simulate a real live picture of the helping agent in the display window 136 (FIG. 7) on the client system #1, 60 the said client system reprocesses the most recent received video frames already stored in its video buffers. The said client system invokes a linkage process which regenerates the essential movements required to present a live picture with the incoming stream of the new voice information. The association process of the new voice information with the previous received video frames creates the impression of a live picture to the client viewing the video display window 136 as shown in FIG. 7.

The client system #1, 60 also continuously monitors the receive data rate. If the corresponding measuring results show that the receive data rate is sustained well above a minimum preconfigured value for a certain amount of time then the said client system sends a message to the said agent system to resume the transmission of the live video.

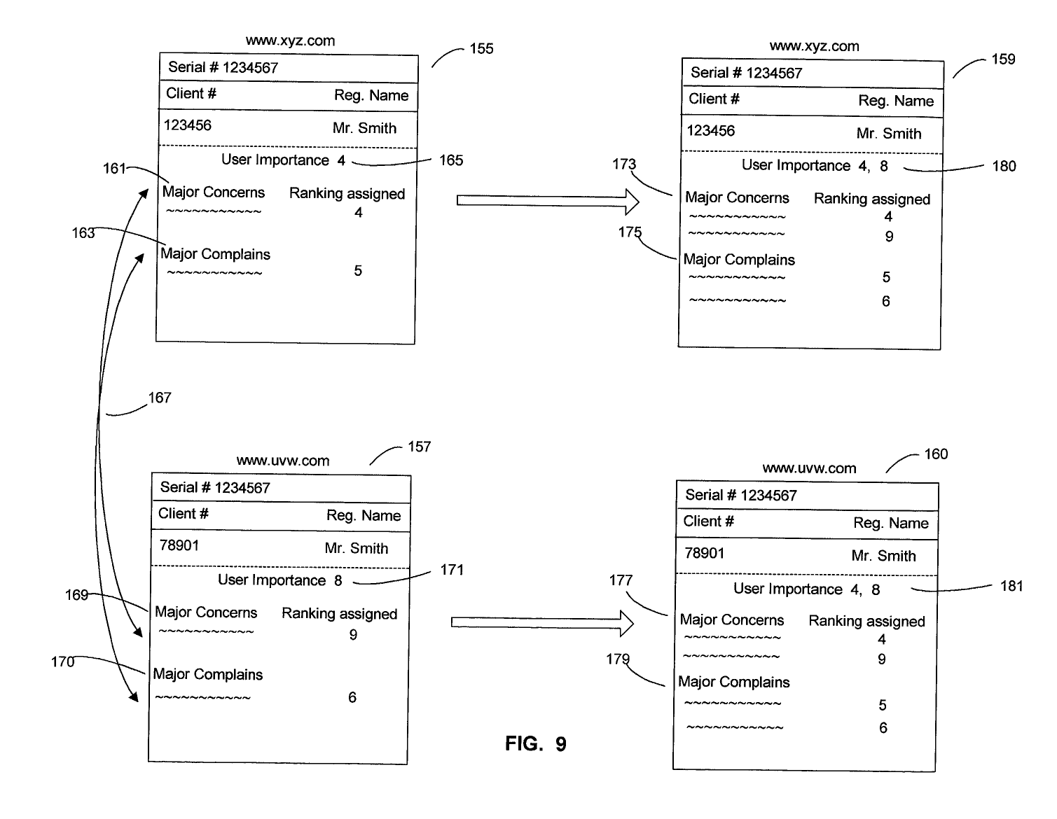

FIG. 9 illustrates a process that can be used to parse and merge related information fields between multiple profiles of single or multiple clients to provide a better quality of service. The two example profiles 155 and 157 contain information about the client, Mr. Smith, belonging to two different Web sites (www.xyx.com and www.uvw.com, respectively). As the said client accesses the mentioned Web sites the respective helping agents interact with the said client and update the information fields in the said profiles 155 and 157. For illustration purposes, three example fields, ‘Client Importance’ 165, ‘Major Concerns’ 161 and, ‘Major Complaints’ 163 are shown in the profile 155. As the helping agent using the said profile at Web site www.xyz.com interacts with the client, the said helping agent can receive the client feedback and can enter the related information against the respective fields. Depending upon the importance and severity of the received information the said helping agent can assign a ranking to the corresponding fields. Similarly, when the said client, Mr. Smith, accesses the Web site www.uvw.com the respective helping agent also updates the corresponding fields with the related said client's experience. The helping agent also assigns a ranking number associated with the respective fields. In order to understand the said client needs better and, also to improve the quality of service, the related fields in the two said profiles 155 and 157 can be merged together. The resulting profiles 159 and 160 include the combined information derived from the individual profiles 155 and 157. Next time when the said client visits these two mentioned Web sites the respective helping agents will have more specific details about the client concerns, complaints and other issues. The assigned ranking can be used by the query engines to sort out clients with different needs, and based on the results, automated systems can forward any useful related information to the clients.

The clients' active profiles can be stored at different locations to meet certain requirements. For instance, the Web server 75 can use its database storage 73 to keep all the client profiles in one centralized location. In the event a client needs to obtain on-line help from a specific Web site then the Web server 75, along with other information, can forward the client profile to the respective agent system. Once the on-line help session is completed the agent system can send back the client profile with updates to the Web server 75. The other option is to keep the client profiles at the respective agent system. In this situation when a client needs help on a certain Web site the Web server 75 retrieves the client profile number stored in its database 69 and forwards the said number to the respective client system. The said client system queries its database through the received profile number to retrieve the actual client profile for further processing.

FIG. 10 illustrates a flow diagram of a routine that is used to prioritize voice/video information over data information. The routine can be incorporated in the software functionality of the client system, gateway, and the agent system. As shown in FIG. 10, step 191 determines if there is any voice/video information ready for transmission. If so, it transfers the voice/video information as shown in step 195 to the lower communication layers for further processing, or else the routine goes to step 193. In step 193 the routine checks for any data information ready to be transmitted. If so, the routine transfers the data information to lower layers, or else the routine goes back to start 190 to await for voice/video information. After transferring the data information in step 197 the routine returns to start 190.

While the particular invention has been described with reference to illustrative embodiments, this description is not meant to be construed in a limiting sense. It is understood that although the present invention has been described in a preferred embodiment, various modifications of the illustrative embodiments, as well as additional embodiments of the invention, will be apparent to persons skilled in the art upon reference to this description without departing from the spirit of the invention, as recited in the claims appended hereto.

All of the U.S. Patents cited herein are hereby incorporated by reference as if set forth in their entirety.

What is claimed as being new and desired to be protected by Letters Patent of the united States as follows:

1. A method and system for providing on-line assistance to the end users in a networking environment through use of multimedia applications comprising;
at a client system,
displaying an icon for on-line help, and
in response to a single action being performed, sending a unique serial number assigned to the said user to a storage media for initializing a help session,
at a storage media,
identifying a user's profile through the received serial number from a client system, and
transmitting the said user's profile information to a multimedia helping agent system,
at the helping agent system,
identifying the user priority through the received user profile information,
based on the priority ranking initializing and establishing a multimedia connection with the client system through one of the many networking connectivity available options, and
transmitting the Web page address information along with multimedia helping information to the client system.

2. The method and system according to claim 1 wherein a client system sends a unique serial number in response to a single action to a designated information storage media.

3. The method and system according to claim 2 wherein a designated storage media maps a unique user's profile information in response a serial number received from a client system.

4. The method and system according to claim 3 wherein a designated storage media sends a unique user profile information to a helping agent's system.

5. The method and system according to claim 3 wherein the user's profile consisting of user's concerns and behavior patterns are consolidated with number ranking from user's visits to different web sites.

6. The method and system according to claim 5 wherein the user's profile contains the aggregated behavioral patterns of a user collected from visiting different web sites

7. The method and system according to claim 1 wherein the level of services to be provided including the network connectivity options are determined from the user's profile.

8. The method and system according to claim 1 wherein the storage media contains the records of the logged-in user that define a user's profile.

8. The method and system according to claim 1 wherein the client system exchanges Web pages with the helping agent system comprising the steps of;
at the client system,
transmitting the web site address currently being displayed at the helping agent system,
at the helping agent system
receiving the web site address from the client system and then directly accessing the contents of the web site through the designated web server.

8. The method and system according to claim 7 wherein either a client system or agent system can be in the control mode and direct the other system to accept its web page address.

9. The method and system according to claim 7 wherein the client system and the helping agent system mutually exchange and update mouse movements and positions co-ordinates.

10. The method and system according to claim 9 wherein client system and the helping agent system can view two different mouse cursors distinguishable from each other on their respective screens.

11. A method and system for providing on-line assistance to the end users in a networking environment through use of multimedia applications comprising:
at a client station,
(a) means for initializing a help session,
(b) means for transferring the web page information to a helping agent system, and
(c) means for transferring mouse co-ordinates to the helping agent system,
at the helping agent system,
(a) means for identifying a user operating on a client system through a unique user's profile,
(b) means for accessing the same Web page information as fetched by the client system,
(c) means for sending the web page address to the client system, and
(d) means for establishing a multimedia session with the client system.

12. The method and system according to claim 11 wherein an agent system establishes a multimedia connection with a client system over Public Switched Telephone Network (PSTN).

13. The method and system according to claim 11 wherein agent system establishes a multimedia connection with the client system over any type of data network.
